(19) United States
(12) Patent Application Publication
(10) Pub. No.: US 2008/0032850 A1
(43) Pub. Date: Feb. 7, 2008

(54) Method for producing simple planetary gear device and simple planetary gear device

(75) Inventor: Masayuki Ishizuka, Obu-shi (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Sumitomo Heavy Industries, Ltd.

(21) Appl. No.: 11/882,446

(22) Filed: Aug. 1, 2007

(30) Foreign Application Priority Data
Aug. 2, 2006 (JP) 2006-210707

(51) Int. Cl. F16H 57/08

(52) U.S. Cl. 475/331; 29/893.1

(57) ABSTRACT

A method for producing simple planetary gear devices is provided in which minimum backlash is satisfactorily realized and maintained with a fewer number of parts without creating any space-related inconveniences. A dummy carrier pin is used which is provided with a rotation support section whose axis can be moved in the radial direction and can support a planetary gear around the rotation support section such that the planetary gear can rotate. The planetary gear is assembled, then, a sun gear is selected and assembled, and the positions of the dummy carrier pin are fixed. Thereafter, the dummy carrier pin is removed, and a carrier pin to be used in actual power transmission is press-fitted into the carrier at the position determined by the dummy carrier pin.

### BACKGROUND OF THE INVENTION

1. Field of the Invention

The present invention relates to a method for producing simple planetary gear devices and simple planetary gear devices produced thereby.

2. Description of the Related Art

A simple planetary gear device is widely used in many applications, which is provided with a sun gear, planetary gears each of which is rotatably supported by a carrier pin extending from a carrier in the axial direction and externally meshes with the sun gear, and an internal gear with which the planetary gears internally mesh.

Engagement of gears within a simple planetary gear device inevitably entails backlash, and reduction of the backlash has become a significant problem especially in the field of precision control of industrial robots and the like.

The most basic method for reducing the backlash is to prepare beforehand a plurality of gears whose tooth thicknesses are slightly different among each other. Gears that come to mesh with the least gap are then selected during actual assembly.

However, this method requires a large number of stocks and significantly reduces the workability during assembly. The reason for this is that, in the case of a simple planetary gear device, there is a problem associated with variations in support positions of the carrier pins with respect to the carrier (i.e., variations in positions of the holes formed in the carrier for accommodating the carrier pins) in addition to variations in size of each gear (such as sun gears, planetary gears, and internal gears). For example, even in the case where the dimensions of a planetary gear are proper, if the support position of the carrier pin with respect to the carrier is shifted to the sun gear side from the proper position, then the sun gear to be assembled should have a tooth thickness that is smaller than the proper value. In addition to this, the internal gear to be selected should have a tooth thickness that is larger than the proper value.

A technology is proposed in Japanese Patent Laid-open Publication No. 2001-271894, which, instead of reducing backlash by such a trial-and-error procedure, attempts to reduce backlash by means of a more simply method, for example, by devising a structural improvement. Specifically, a cross-sectional shape of the carrier pin is made elliptic such that the major and minor axes thereof are aligned in the tangential and radial directions, respectively, of the sun gear. Then, a planetary gear having an engagement hole of the perfect circular shape is brought to engage with some play with the carrier pin having the elliptic cross-section. According to this structure, the planetary gear can be moved more in the radial direction than in the direction of the rotation of the sun gear, and the proper engagement of the sun gear, the planetary gears, and the internal gear can be maintained without requiring sophisticated dimensional precision of respective parts. In addition, since a gap around the carrier pin within the engagement hole of the planetary gear is set to be smaller in the circumferential direction than in the radial direction, improvement in the degree of flexibility in assembling parts and reduction of backlash can be simultaneously accomplished as needed.

On the other hand, in Japanese Patent Laid-open Publication No. 2002-206600, another structure is proposed where a carrier pin has a rotation support section whose axis is eccentric with respect to the axis of the carrier pin itself, and the planetary gear can be rotatably supported around the rotation support section. Specifically, each planetary gear is assembled in a configuration where it is proximate to the internal gear by adjusting the orientation of eccentricity of the carrier pin, and, then, a sun gear having a large tooth thickness is selected and assembled. According to such a structure, the three gear members, namely, the internal gear, the planetary gears, and the sun gear, can be assembled with almost no gaps, thereby obtaining a simple planetary gear device with small backlash.

In the simple planetary gear device disclosed in Japanese Patent Laid-open Publication No. 2001-271894, the structure requires that the planetary gear be assembled “with some play” with respect to the carrier pin. This means that the rotational axis of the planetary gear can move about within this play and cannot be uniquely determined with respect to the carrier.

In the simple planetary gear device disclosed in Japanese Patent Laid-open Publication No. 2002-206600, the structure requires that the carrier pin be assembled such that it is allowed to “rotate” with respect to the carrier in order to select the eccentricity orientation of the carrier pin. Therefore, a diameter of the carrier pin support hole in the carrier for accommodating a carrier pin is set at values that allow the carrier pin to be assembled “with some play” (specifically, a gap between the carrier pin and the inner circumference of the carrier pin support hole is set at approximately 1 to 20 μm, for example). Consequently, the planetary gear is assembled such that the rotational axis of the planetary gear can move about as the eccentricity orientation of the carrier pin varies. In addition to this, its pivoting point is not uniquely determined with respect to the carrier.

These functions are two sides of the same coin when realizing “the movement of the rotational axis of the planetary gear” described in Japanese Patent Laid-open Publications No. 2001-271894 and No. 2002-206600 and cannot be avoided.

However, in precision simple planetary gear devices used in industrial robots of recent years, there may be cases where minute backlash such as 3 arc·min or less, for example, must be realized. Such demand may be difficult to satisfy with structures such as those mentioned above because a gap attributable to assembling parts with some play causes backlash.

With regard to this point, an additional technology is further proposed in Japanese Patent Laid-open Publication No. 2002-206600, where the eccentricity orientation of the carrier pin is fixed with respect to the carrier after assembling the sun gear. However, since the optimum eccentricity orientation cannot be known beforehand with this fixation process, (as disclosed in Japanese Patent Laid-open Publication No. 2002-206600) there is no choice but to fix the eccentricity orientation of the carrier pin with respect to the carrier by bolts or the like only after probing the eccentricity orientation. As a result, actual design of such processes was extremely difficult in view of space-related requirement or reliability concerning long-term stability.

### SUMMARY OF THE INVENTION

The present invention was developed in view of such conventional problems, and an object of the present invention is to provide a simple planetary gear device that is capable of satisfactorily realizing minimum backlash with a small number of parts without creating any space-related inconvenience.

The present invention provides a method for producing a simple planetary gear device including a sun gear, a planetary gear which is rotatably supported by a carrier pin inserted into a carrier and externally meshes with the sun gear, and an internal gear with which the planetary gear internally meshes. In order to solve the above-mentioned problems, the method includes the steps of: preparing the carrier pin that is eventually to be assembled with a tight interference into the carrier and a dummy carrier pin which is provided with a rotation support section of the same shape as that of the carrier pin for supporting the planetary gear and can be assembled such that a center position of the rotation support section thereof can be moved in a radial direction of the simple planetary gear device; assembling the planetary gear with the dummy carrier pin being inserted into the carrier while adjusting a radial position of the rotation support section of the dummy carrier pin; selecting the sun gear having a tooth thickness capable of satisfying required backlash from a group of sun gears prepared in advance and, with this state being maintained, assembling the selected sun gear; fixing the assembled planetary gear at an assembled position; removing the dummy carrier pin; assembling the carrier pin with a tight interference into the carrier at a position determined by the dummy carrier pin with the fixed planetary gear; and releasing the fixation of the planetary gear.

Basically, in the present invention, a carrier pin that is provided with a rotation support section for the planetary gear and can be assembled in such a manner that the center position of the rotation support section can be moved in the radial direction of the simple planetary gear device is used. However, in the present invention, these carrier pins are not used during assembly from the start. Instead, the dummy carrier pin is used first, and the planetary gear is assembled (basically, so as to bring closer to the internal gear) while adjusting the radial position (for example, eccentricity orientation) of the dummy carrier pin. Then, with this state being maintained, a sun gear that has a tooth thickness capable of realizing required backlash is selected from a group of sun gears which have been prepared in advance and assembled. In general, the larger the tooth thickness of the selected sun gear is, the smaller the backlash becomes. Accordingly, a combination of the internal gear, the planetary gear, and the sun gear capable of realizing the minimum backlash, as well as their optimal assembled positions, are basically determined.

In the present invention, the assembled configuration of the planetary gear is fixed here, and the dummy carrier pin is removed. Then, the essential carrier pin (that to be used in actual power transmission) is assembled into the carrier with a tight interference at the radial position determined by the dummy carrier pin with the fixed planetary gear. The expression “assembled with a tight interference” specifically refers to the configuration where a concave part (or a hole) is designed to be smaller in size than a convex part to be fitted therein such as press-fitting, shrink fitting, and expansion fitting. By assembling parts with a tight interference, the positional configuration of the rotation support section of the carrier pin in the radial direction with respect to the carrier remains fixed even if the fixation of the planetary gears is released. Accordingly, the rotational axis of the planetary gear with respect to the carrier is immovably finalized with minimum backlash.

Since the carrier pin is assembled into the carrier with “a tight interference,” fixation means such as bolts is not needed when fixing the radial position of the carrier pin, and accordingly, any special spaces is not required for such fixation means. Furthermore, since the assembly with a tight interference is unlikely to develop any inconveniences such as a loose bolt in fixing with a bolt, its fixation function remains stable.

Furthermore, since no part members except the sun gear are responsible for the backlash adjustment (this means that a plurality of part members with slightly different tooth thicknesses is required for the sun gear only), an increase in the number of stocks can also be prevented.

When considering the present invention as a device invention, the present invention provides a simple planetary gear device including a sun gear, a planetary gear which is rotatably supported by a carrier pin extending from a carrier in an axial direction and externally meshes with the sun gear, and an internal gear with which the planetary gear internally meshes. In this simple planetary gear device configured as above, the carrier pin is provided with a rotation support section for the planetary gear and can be assembled in such a manner that a center position of the rotation support section thereof can be moved in a radial direction of the simple planetary gear device, and the carrier pin is press-fitted into the carrier.

When “a carrier pin that can be assembled in such a manner that the center position of the rotation support section for the planetary gear can be moved in the radial direction of the simple planetary gear device” is used as the carrier pin, that carrier pin will not be assembled into the carrier with a tight interference (in a typical production process). The reason for this is that, once assembled with a tight interference, the function of probing the optimal radial position cannot be performed. However, by following the procedure signifying the essence of the present invention, namely, “a procedure where, after probing with the dummy carrier pin the optimal radial position of the rotation support section, the optimal radial position is fixed and maintained by fixing the planetary gear, and, then, the essential carrier pin (that to be used in the actual power transmission) is assembled with a tight interference so as to follow the dummy carrier pin,” a simple planetary gear device in which the carrier pin is assembled with a tight interference while simultaneously providing the advantage of freely assembling parts in the radial direction can be consequently realized.

According to the present invention, a simple planetary gear device that is capable of satisfactorily realizing and maintaining minimum backlash with a fewer number of stocks without developing space-related inconveniences or the like can be obtained.

### BRIEF DESCRIPTION OF THE DRAWINGS

FIG. 1 is a cross-sectional view of a simple planetary gear device produced by a production method according to an embodiment of the present invention with variations of the carrier pin being additionally illustrated;

FIGS. 2A, 2B, and 2C are process drawings showing a production method of a simple planetary gear device with large backlash, using parts of a simple planetary gear device according to the present invention;

FIG. 3 is a perspective view illustrating a configuration in which planetary gears are assembled with dummy carrier pins in one step of an assembling method according to an embodiment of the present invention;

FIGS. 4A and 4B are side views illustrating a procedure for probing the optimal eccentricity position;

FIG. 5 is a cross-sectional view illustrating a configuration in which a dummy carrier pin and a sun gear are assembled;

FIG. 6 is a cross-sectional view illustrating a configuration in which a fixture jig is assembled;

FIG. 7 is a cross-sectional view illustrating a configuration in which the dummy carrier pin has been removed;

FIG. 8 is a cross-sectional view illustrating a configuration in which an eccentric carrier pin has been press-fitted and then the fixture jig has been removed;

FIG. 9 is a perspective view illustrating a configuration in which the second carrier has been assembled; and

FIG. 10 is a plan view illustrating an arrangement of the first carrier and the carrier pins (dummy carrier pins) according to one example of another embodiment of the present invention.

### DETAILED DESCRIPTION OF THE PREFERRED EMBODIMENTS

Hereinafter, one example of an embodiment of the present invention will be described with reference to the accompanying drawings.

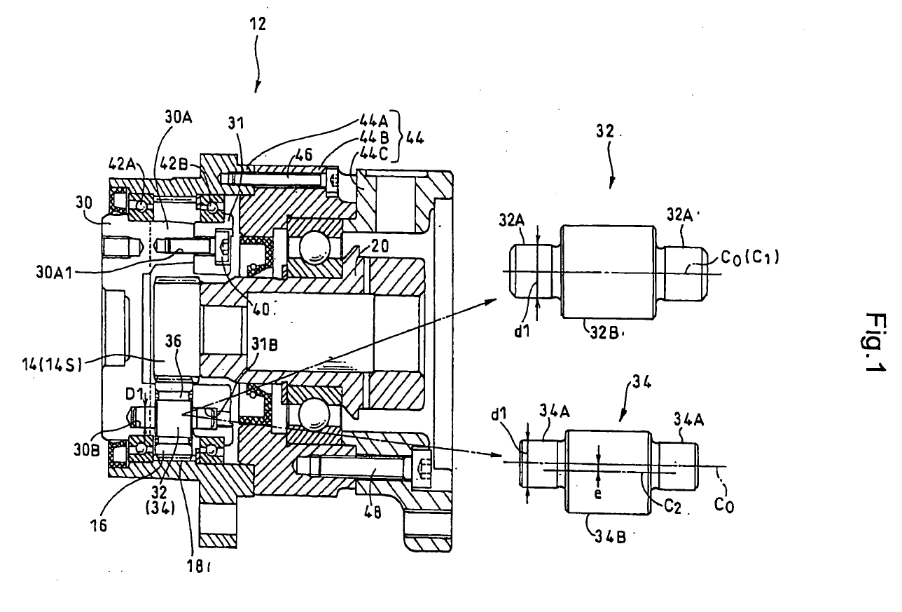

FIG. 1 illustrates a main structure characteristic to a series (an aggregation of product groups) of simple planetary gear devices including a simple planetary gear device according to an embodiment of the present invention. This series enables users to make a choice between a product group having large backlash (large backlash will be permitted) and a product group having small backlash (only small backlash will be permitted) while the same structure is being maintained with respect to the reduction ratio, the transmission capacity, and the like. For the product group of large backlash, a concentric carrier pin with no eccentricity is used, and, for the product group of small backlash, an eccentric carrier pin that is capable of realizing the present invention is used. For convenience' sake, a general structure of the simple planetary gear device will be described first.

The simple planetary gear device 12 is configured to include a sun gear 14 (14S: to be described later), three planetary gears 16 (only one of them is shown in the figure) externally meshing the sun gear 14, and an internal gear 18 with which the planetary gears 16 internally mesh.

The sun gear 14 is press-fitted and secured to a hollow sun gear shaft 20.

The planetary gear 16 is rotatably supported by a first carrier (carrier) 30 and a second carrier (sub-carrier) 31 through a concentric carrier pin 32 (or an eccentric carrier pin 34) and a needle bearing 36.

The first carrier 30 also serves as an output shaft. The first carrier 30 is coupled to the second carrier (sub-carrier) 31 by a bolt 40 through a coupling section 30A. The first and second carriers 30 and 31 are rotatably supported by a casing 44 (a first casing 44A) through bearings 42A and 42B, respectively. A bolt hole 30A1 formed in the coupling section 30A (for screw-mounting by the bolt 40) is used not only for the coupling of the first and second carriers 30 and 31 but also for the fixation of planetary gears by a fixture jig to be described later.

The above-mentioned concentric carrier pin 32 is used when a group of products with large backlash is to be produced. The concentric carrier pin 32 is provided with insertion sections 32A to be inserted into the first and second carriers 30 and 31 and a rotation support section 32B for the planetary gear 16. The center Co of the insertion sections 32A and the center C1 of the rotation support section 32B (or a rotation center of the planetary gear 16) are concentric. Furthermore, an outer diameter d1 of the insertion section 32A (carrier pin diameter) is larger than an inner diameter D1 of the insertion holes 30B and 31B, the former being on the first carrier 30 side and the latter being on the second carrier 31 side, by a dimension corresponding to the tight interference for press fitting.

Conversely, the eccentric carrier pin 34 is used when a group of products with small backlash is to be produced. The eccentric carrier pin 34 is provided with insertion sections 34A to be inserted into the first and second carriers 30 and 31 and a rotation support section 34B for the planetary gear 16. However, the center Co of the insertion sections 34A and the center C2 of the rotation support section 34B are not concentric but eccentric from each other by a distance e. An outer diameter of the insertion section 34A of the eccentric carrier pin 34 is d1, which is the same as the outer diameter of the insertion section 32A of the concentric carrier pin. Therefore, the outer diameter of the insertion section 34A of the eccentric carrier pin 34 is larger than the inner diameter D1 of the insertion holes 30B and 31B, the former being on the first carrier 30 side and the latter being on the second carrier 31 side, by dimension corresponding to a tight interference for press fitting. A method of assembling the carrier pins 32 and 34 will be described later.

A casing 44 is made of first, second, and third casings, which are designated by 44A, 44B, and 44C, respectively, and is assembled as a united body by bolts 46 and 48.

The internal gear 18 is integrated with the casing 44 (the first casing 44A) and internally meshed by the planetary gears 16.

Now, a method for producing that simple planetary gear device 12 will be described in detail.

When a group of products with large backlash are to be produced, the concentric carrier pins 32 are used.

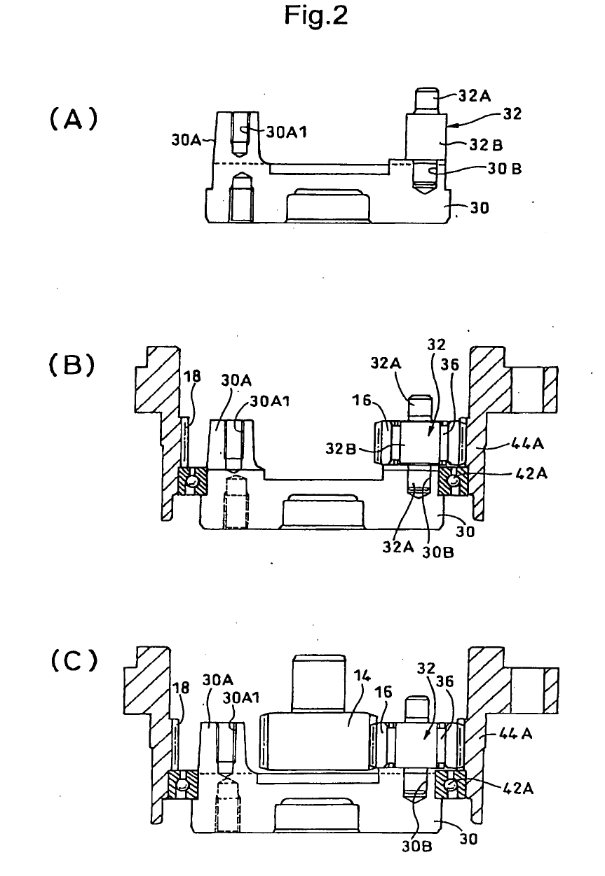

With reference to FIG. 2A, since the concentric carrier pin 32 is not capable of changing a position of the rotational axis Co of the planetary gear 16, it is directly “press-fitted” into the insertion hole 30B of the first carrier 30.

Next, the planetary gear 16 is assembled onto this concentric carrier pin 32 with the needle bearing 36 being inserted between the two (FIG. 2B). The dimensions of the planetary gear 16 and the internal gear 18 are determined in advance such that they mesh with a prescribed gap (corresponding to backlash) being formed between the two. Therefore, regardless of the product-to-product variation of these gears, they can certainly be assembled without fail.

Next, the sun gear 14 is assembled with that state being maintained. The dimensions of the planetary gear 16 and the sun gear 14 are also determined in advance such that they mesh with a prescribed gap (corresponding to backlash) being formed between the two. Therefore, regardless of the product-to-product variation, they can certainly be assembled without fail.

Next, the second carrier 31 is assembled using the bolt 40. Then, after temporarily removing the sun gear 14 and placing it into the sun gear shaft 20, the simple planetary gear device 12 as illustrated in FIG. 1 is obtained with additional steps such as reassembling the sun gear 14 so that it meshes with the planetary gears 16.

As described above, when producing (a product group of) the simple planetary gear devices 12 with large backlash, none of the sun gear 14, the planetary gears 16, and the internal gear 18 requires a step of “selection.” What is required is simply to assemble those that have been finished to standard dimensions, and, consequently, production steps can be considerably simplified.

On the other hand, when a group of products with small backlash are to be produced, the eccentric carrier pins 34, in which the center C2 of the rotation support section 34B is eccentric with respect to the center Co of the insertion section 34A, are used. However, instead of directly assembling the eccentric carrier pin 34, a dummy eccentric carrier pin (dummy carrier pin) 50 is used in the preceding step.

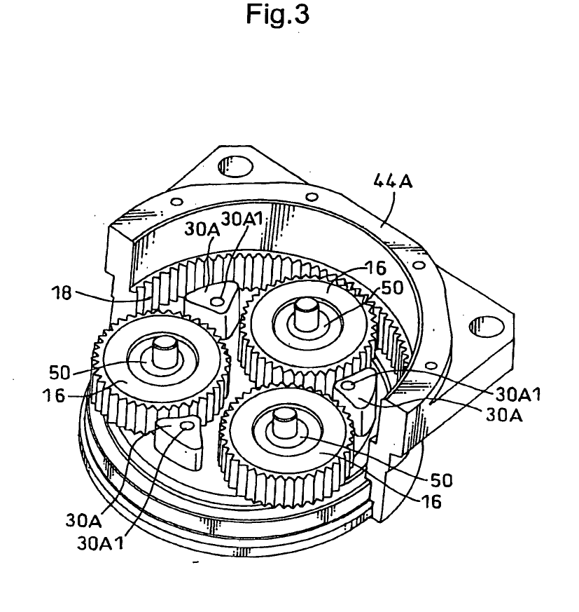

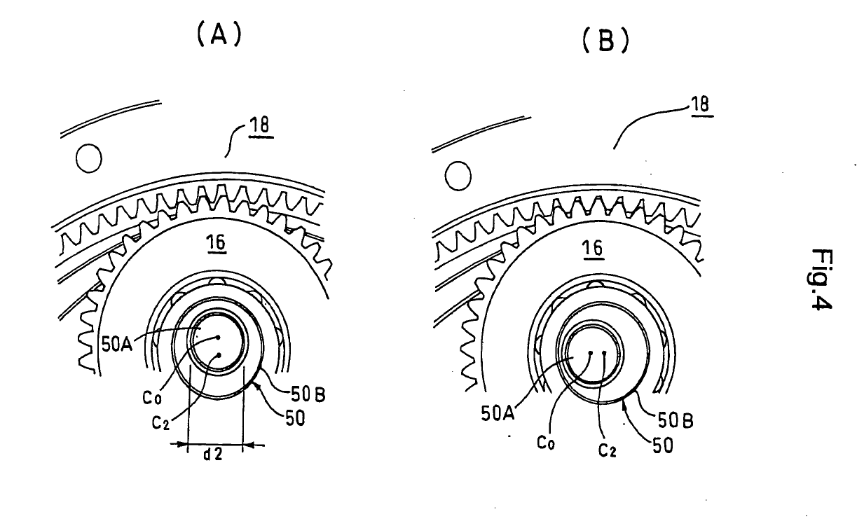

The dummy carrier pin 50 basically has the same shape as the eccentric carrier pin 34. However, an outer diameter d2 of an insertion section 50A (see FIG. 4) has been set to be slightly smaller than the outer diameter d1 of the insertion section 34A of the eccentric carrier pin 34 so that it can be inserted with some play into the insertion hole 30B of the first carrier 30. This dummy carrier pin 50 is used to assemble the planetary gear 16 such that it meshes with the internal gear 18. FIG. 3 illustrates an assembled configuration.

In this instance, both the planetary gears 16 and the internal gear 18 are those that have been finished to standard dimensions and exactly the same as those used in producing the before-mentioned group of products with large backlash. In other words, they are not those specifically “selected,” and both the planetary gears 16 and the internal gear 18 have been designed to certain dimensions with prescribed backlash. However, since, in the dummy carrier pin 50, the center Co of the insertion section 50A and the center C2 of the rotation support section 50B are deviated from each other by a distance e, the center (that is, the rotational axis) C2 of the planetary gear 16 can be moved in the radial direction by turning the dummy carrier pin 50 about the center Co of the insertion section 50A as comparatively illustrated in FIGS. 4A and 4B. Therefore, even if those that have been finished to standard dimensions are used as the planetary gears 16 and the internal gear 18, a configuration with almost no backlash between the planetary gear 16 and the internal gear 18 (the configuration of FIG. 4B) can be achieved.

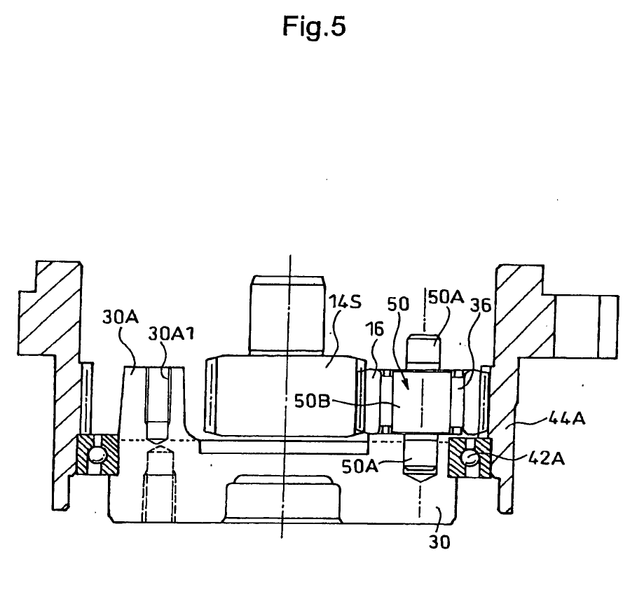

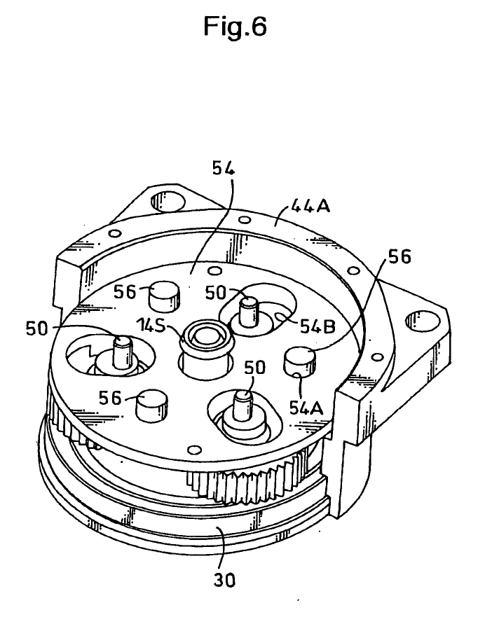

The planetary gear 16 is thus assembled in such a manner that, while the orientation of eccentricity (radial position) of the rotation support section 50B of the dummy carrier pin 50 is being adjusted, the planetary gear 16 meshes with the internal gear 18 in a configuration in which they come within the closest possible distance. Then, from a plurality of sun gears that have been prepared in advance, one sun gear 14S having a tooth thickness capable of satisfying required backlash is selected and assembled (see FIG. 5). When considering qualitatively, selecting and assembling a sun gear 14S having the largest possible tooth thickness allows an assembly with the smallest possible backlash for the entire gear device. However, since the gear device rotates more smoothly with minute backlash, it is preferable that a sun gear 14S having a tooth thickness that is neither too much nor too little and satisfies required backlash be selected and assembled.

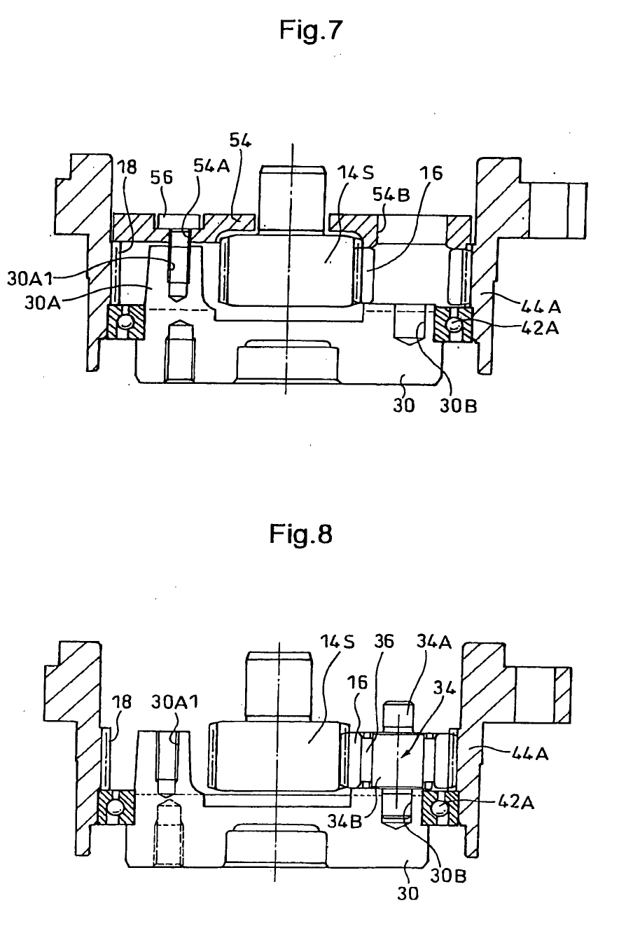

Then, the planetary gears 16 are fixed with respect to the first carrier 30 by a fixture jig 54 (see FIG. 6). This fixation is performed by screwing a bolt 56 into the bolt hole 30A1 of the coupling section 30A of the first carrier 30 with the fixture jig 54 being inserted between the two so that the planetary gears 16 are firmly pinched by the first carrier 30 and the fixture jig 54. The fixture jig 54 is provided with three through holes 54A for accommodating the bolts 56 and three insertion holes 54B for replacing the dummy carrier pin 50 with the eccentric carrier pin 34 to be used in actual power transmission (see FIGS. 6 and 7).

After fixing the planetary gears 16, the dummy carrier pins 50 are removed through the insertion holes 54B (see FIG. 7). In this process, since the planetary gears 16 are being fixed with respect to the first carrier 30 by the fixture jig 54, the orientation of eccentricity determined by the dummy carrier pins 50 are maintained.

Then, the eccentric carrier pins 34 are press-fitted into the first carrier 30 in such a manner that they follow the orientation of eccentricity determined by the dummy carrier pins 50 with the planetary gears 16. After the press-fit, the fixture jig 54 is removed, thereby releasing the fixation of the planetary gears 16 (see FIG. 8).

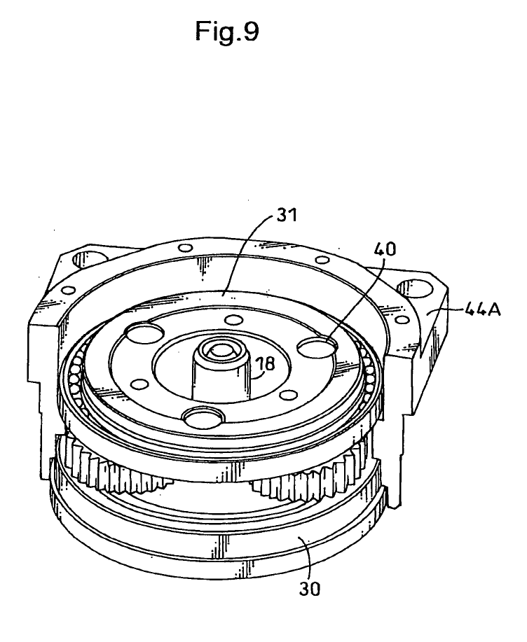

After removing the fixture jig 54, the second carrier 31 is assembled using bolts 40 while reusing the bolt holes 30A1 of the coupling section 30A (see FIGS. 9 and 1).

In the production method in accordance with the present embodiment, only the sun gear 14 is prepared as a plurality of gears with different tooth thicknesses for adjusting the backlash while the internal gear 18 and the planetary gears 16 to be used are prepared as a single gear type. Accordingly, it is possible to ensure that the backlash of the simple planetary gear device 12 be kept within an intended range, including an ultra-small level such as 3 arc·min or less.

Furthermore, though the orientation of eccentricity of the eccentric carrier pin 34 is varied to adjust the position of the rotational axis of the planetary gear 16, the orientation of eccentricity of the eccentric carrier pin 34 is fixed by its “press-fitting” into the (first) carrier 30. Therefore, the configuration of the assembled simple planetary gear device 12 is considerably simplified, and the miniaturization and weight reduction of the gear device are possible. Furthermore, the fixation of the eccentric carrier pin 34 by the press-fitting is reliable over time, and the minimum backlash can be properly maintained for a long period of time.

Furthermore, in this embodiment, when producing simple planetary gear devices of the same capacity and the same reduction ratio but of different backlash requirement, respective production steps are varied so that parts sharing as well as the simplification of overall production steps can be achieved. In other words, when the backlash requirement is not very strict, the same internal gear and planetary gears as those used when the backlash requirement is strict can be used, but without performing any work concerning trial-and-error or replacement of carrier pins, thereby producing gear devices in a considerably simplified manner. It should be noted, however, that the preparation of such a series of products is not an essential requirement when carrying out the present invention.

Though the planetary gears are fixed by a fixture jig in the above-described embodiment, a method of fixing the planetary gears is not limited to methods using such a fixture jig. Furthermore, though bolt holes for coupling the first carrier (carrier) and the second carrier (sub-carrier) also serve as bolt holes for fixing the planetary gears, this sharing of bolt holes is not an essential requirement of the present invention.

Furthermore, in the above-described embodiment, the eccentric carrier pins are used to achieve a structure in which the rotation support section for the planetary gear can be moved in the radial direction of the simple planetary gear device. However, such a structure in which the position of the center of the rotation support section can be moved in the radial direction is not limited to those in which such eccentric carrier pins as mentioned above are used.

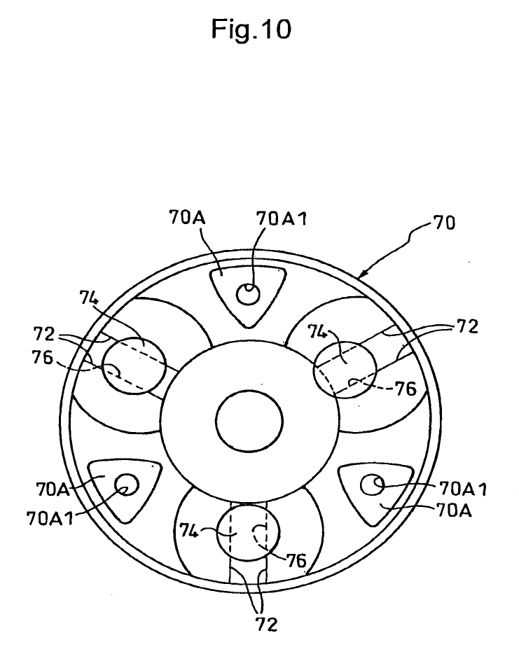

For example, as shown in FIG. 10, a first carrier 70 may be provided with three grooves 76, each being formed by mutually parallel steps 72 and arranged in the radial direction. Then, dummy carrier pins (74) each of which slidably engages with this groove 76 and carrier pins 74 (to be used in actual power transmission) each of which engages the groove 76 with a tight interference may be prepared. In this case, each planetary gear (not shown in FIG. 10) is assembled while making use of a sliding motion of the dummy carrier pin (74) on the groove 76 in the radial direction, and the properly placed planetary gears are fixed using the bolt holes 70A1 formed in coupling sections 70A. Then, after removing the dummy carrier pins (74), each carrier pin 74 that is to be used in actual power transmission is press-fitted (assembled with a tight interference) into the groove 76, thereby realizing basically the same function and effect as the above-described embodiment.

The present invention can be used in any applications but, in particular, is most suited to applications where operation with small backlash is required such as joint movement of industrial robots or movement of positioning device.

The disclosure of Japanese Patent Application No. 2006-210707 filed Aug. 2, 2006 including specification, drawing and claim are incorporated herein by reference in its entirety.

What is claimed is:

1. A method for producing a simple planetary gear device including a sun gear, a planetary gear which is rotatably supported by a carrier pin inserted into a carrier and externally meshes with the sun gear, and an internal gear with which the planetary gear internally meshes, the method comprising the steps of:
preparing the carrier pin that is eventually to be assembled with a tight interference into the carrier, and a dummy carrier pin which is provided with a rotation support section of a same shape as that of the carrier pin for supporting the planetary gear and can be assembled such that a center position of the rotation support section thereof can be moved in a radial direction of the simple planetary gear device;
assembling the planetary gear with the dummy carrier pin being inserted into the carrier while adjusting a radial position of the rotation support section of the dummy carrier pin;
with this state being maintained, selecting the sun gear having a tooth thickness capable of satisfying required backlash from a group of sun gears prepared in advance, and assembling a selected sun gear;
fixing a assembled planetary gear at an assembled position;
removing the dummy carrier pin;
assembling the carrier pin with a tight interference into the carrier at a position determined by the dummy carrier pin with a fixed planetary gear; and
releasing a fixation of the planetary gear.

2. The method for producing a simple planetary gear device according to claim 1, further comprising, after the step of releasing the fixation of the planetary gear, a step of assembling a sub-carrier that cooperates with the carrier in supporting the carrier pin at both ends thereof on an opposite side of the planetary gear to the carrier.

3. The method for producing a simple planetary gear device according to claim 2, wherein the sub-carrier is assembled using a bolt hole used for fixing the planetary gear.

4. A set of assembly components for producing a simple planetary gear device comprising:
a plurality of sun gears, each sun gear having a different tooth thickness with each other;
a planetary gear enabling to externally mesh with one of the sun gear;
an internal gear with which the planetary gear internally meshes;
a carrier pin that is eventually to be assembled with a tight interference into a carrier for supporting the planetary gear; and
a dummy carrier pin which is provided with a rotation support section of a same shape as that of the carrier pin for supporting the planetary gear and can be assembled into the carrier such that a center position of the rotation support section thereof can be moved in a radial direction of the simple planetary gear device, and can be removed from the carrier.

5. A simple planetary gear device comprising:
a sun gear;
a planetary gear externally meshing with the sun gear;
an internal gear with which the planetary gear internally meshes; and
a carrier pin extending from a carrier in an axial direction for supporting the planetary gear, wherein
the carrier pin is provided with a rotation support section for the planetary gear and can be assembled in such a manner that a center position of the rotation support section thereof can be moved in a radial direction of the simple planetary gear device, and the carrier pin is assembled into the carrier with a tight interference.
